(19) United States
(12) Patent Application Publication
(10) Pub. No.: US 2007/0276091 A1
(43) Pub. Date: Nov. 29, 2007

(54) Organic insulating film composition and method of manufacturing organic insulating film having dual thickness using the same

(75) Inventors: Kyung Seok Son, Seoul (KR); Jung Seok Hahn, Seongnam-si (KR); Hyun Sik Moon, Seoul (KR); Sang Yoon Lee, Seoul (KR); Eun Jeong Jeong, Seongnam-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/727,758

(22) Filed: Mar. 28, 2007

(30) Foreign Application Priority Data
May 26, 2006 (KR) 10-2006-0047761

(51) Int. Cl. C08L 83/00; C08F 8/00

(52) U.S. Cl. 525/100

(57) ABSTRACT

Disclosed are an organic insulating film composition for use in the formation of an insulating film having a dual thickness using the hydrophilic/hydrophobic difference between a substrate and a gate electrode, and a method of manufacturing an organic insulating film having a dual thickness using the same. In a display device using a thin film transistor including the organic insulating film of example embodiments, flickering caused by parasitic capacitance may be decreased, and thus reliability may be increased, enabling a simpler manufacturing process and decreased manufacturing cost.

### PRIORITY STATEMENT

This non-provisional application claims priority under U.S.C. §119 to Korean Patent Application No. 10-2006-0047761, filed on May 26, 2006, in the Korean Intellectual Property Office (KIPO), the entire contents of which are herein incorporated by reference.

### BACKGROUND

1. Field

Example embodiments relate to an organic insulating film composition and a method of manufacturing an organic insulating film having a dual thickness using the same. Other example embodiments relate to an organic insulating film composition, suitable for use in forming an insulating film having a dual thickness using the hydrophilic/hydrophobic difference between a substrate and a gate electrode, and to a method of manufacturing an organic insulating film having a dual thickness using the same.

2. Description of the Related Art

In general, a thin film transistor (TFT), which may be formed on a substrate having an increased area, has to date been developed and commercialized into liquid crystal displays, peripheral devices, e.g., laser printer heads, and/or image sensors, for example, scanners and/or smart cards. Recently, TFTs have been used in the operation of full color organic electroluminescent displays.

Further, because the TFT is manufactured in the form of a thin film, the TFT may be applied to the manufacture of a product which is relatively light and may be easily portable. Each pixel for use in an active display may be provided with a transistor manufactured in a thin film. Because the TFT is characterized by decreased power consumption and rapid switching and the brightness of pixels thereof may be controlled by varying the magnitude of current, the TFT plays an important role in displays having increased image quality. Such a TFT may be a silicon TFT, which uses amorphous Si and/or polycrystalline Si as a channel material constituting a semiconductor layer, and an organic TFT, (OTFT) which uses an organic semiconductor, e.g., pentacene and/or polythiophene.

FIG. 1 is a cross-sectional view of the unit cell of a conventional TFT LCD. As shown in FIG. 1, a gate electrode 20 and a storage electrode 15, spaced apart by a predetermined or given interval, may be formed on a substrate 10, and a gate insulating film 30 may be formed on the entire upper surface of the substrate 10. On the gate insulating film 30, a semiconductor layer 50 may be formed in a predetermined or given pattern through a known process, and a drain electrode 60 and a source electrode 40, which are formed together upon the formation of a data line 25, may be spaced apart from each other on the semiconductor layer 50. In addition, the upper portion of the substrate 10 having the above structure may be coated with an organic insulating film 35, and such an organic insulating film 35 may be provided with a contact hole (not shown) for exposing the source electrode. Further, a pixel electrode 45 may be formed to partially overlap the gate electrode 20 and the data line 25 while contacting the source electrode 60 through the contact hole at a position corresponding to the pixel region on the organic insulating film 35.

FIG. 2 is a schematic cross-sectional view of a conventional silicon TFT used in an LCD. As shown in FIG. 2, the conventional silicon TFT may be composed of a substrate 10, a gate electrode 20, a gate insulating film 30, a source electrode 60, a drain electrode 40, and a semiconductor layer 50.

In such a conventional TFT, due to parasitic capacitance between the gate electrode 20 and the source/drain electrodes 40, 60, voltage shift of pixel voltage may occur. Such voltage shift may be referred to as kickback voltage (V_{kb}). When kickback voltage increases, a flickering phenomenon may occur, undesirably decreasing the reliability of the LCD. Such parasitic capacitance may be decreased by increasing the thickness of the gate insulating film 30 between the gate electrode 20 and the source/drain electrodes 40, 60. However, the properties of the TFT may be deteriorated and the aperture ratio may also be decreased.

FIG. 3 is a schematic cross-sectional view showing the structure of a conventional OTFT. As shown in FIG. 3, the OTFT typically may include a substrate 310, a gate electrode 320, a gate insulating film 330, a source electrode 360, a drain electrode 340, and an organic semiconductor layer 350. Upon the formation of the organic semiconductor layer, a bank 370 dividing the pixel region may be further included to prevent or reduce cross-talk between pixels. The OTFT manufacturing method essentially requires a bank formation process, such bank formation process being additionally performed through photolithography and/or plasma surface treatment. Upon the manufacture of the OTFT, the overall manufacturing process may be complicated and the manufacturing cost may be increased, attributed to the additional bank formation process.

### SUMMARY

Accordingly, example embodiments are provided for addressing certain of the deficiencies and/or limitations of the related art through the manufacture and use of an organic insulating film composition, which is suitable for use in the formation of an insulating film having a dual thickness, which includes a smaller thickness on the upper portion of an electrode and a larger thickness on the upper portion of a substrate using the hydrophilic/hydrophobic difference between the substrate and the electrode, and a method of manufacturing an organic insulating film using the same.

Example embodiments provide a TFT including the organic insulating film, which has increased charge mobility, an increased on-off ratio, and an increased aperture ratio and may decrease parasitic capacitance so as to enable the control of a flickering phenomenon.

Example embodiments provide a display device and an electronic device, each of which may include the TFT, thus increasing reliability and decreasing the manufacturing cost.

Example embodiments provide an organic insulating film composition, including a polysiloxane polymer, a hydrophobic or hydrophilic controller, and a solvent.

In addition, example embodiments provide a method of manufacturing an organic insulating film having a dual thickness, including coating a substrate having an electrode formed thereon with an organic insulating film composition having hydrophobicity or hydrophilicity equal to or similar to both the substrate and the gate electrode, thus forming an insulating film having a dual thickness.

In addition, example embodiments provide a method of manufacturing an OTFT, including performing the method of manufacturing the organic insulating film having a dual thickness according to example embodiments; and forming an organic semiconductor layer on the bottom of a groove formed by the difference in thickness of the gate insulating film.

Example embodiments may also include a polysiloxane polymer composition comprising an organic-inorganic hybrid material obtained by hydrolyzing and polycondensing at least one organic silane compound selected from the group consisting of compounds represented by Formulas 1 to 3 below, or mixtures thereof:

SiX₁X₂X₃X₄ Formula 1

R₁SiX₁X₂X₃ Formula 2

R₁R₂SiX₁X₂ Formula 3

in Formulas 1 to 3, X₁, X₂, X₃ and X₄ are each independently selected from the group consisting of a halogen atom, a substituted or unsubstituted C₁-C₂₀ alkoxy group, and a substituted or unsubstituted C₆-C₂₀ aryloxy group, at least one of which is a hydrolysable functional group, and R₁ and R₂ are each independently selected from the group consisting of a hydrogen atom, a halogen atom, a hydroxyl group, a substituted or unsubstituted C₁-C₂₀ alkyl group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ arylalkyl group, a substituted or unsubstituted C₁-C₂₀ alkoxy group, and a substituted or unsubstituted C₆-C₂₀ aryloxy group.

In addition, example embodiments provide an organic insulating film having a dual thickness formed through the method mentioned above, and a TFT and a display device and/or electronic device, each including such an insulating film.

### BRIEF DESCRIPTION OF THE DRAWINGS

Example embodiments will be more clearly understood from the following detailed description taken in conjunction with the accompanying drawings. FIGS. 1-7B represent non-limiting, example embodiments as described herein.

FIG. 1 is a cross-sectional view of the unit cell of a conventional TFT LCD;

FIG. 2 is a schematic cross-sectional view of a conventional silicon TFT;

FIG. 3 is a schematic cross-sectional view of a conventional OTFT;

FIG. 4 is a schematic cross-sectional view of the silicon TFT including an organic insulating film according to example embodiments;

FIG. 5 is a schematic cross-sectional view of the OTFT including an organic insulating film according to example embodiments;

FIG. 6 is a curve showing current transfer properties of the OTFT manufactured in Example 2;

FIG. 7A is a scanning electron microscope (SEM) picture of the organic insulating film prepared in the example; and

FIG. 7B is a three-dimensionally reconstructed image of the SEM picture of FIG. 7A.

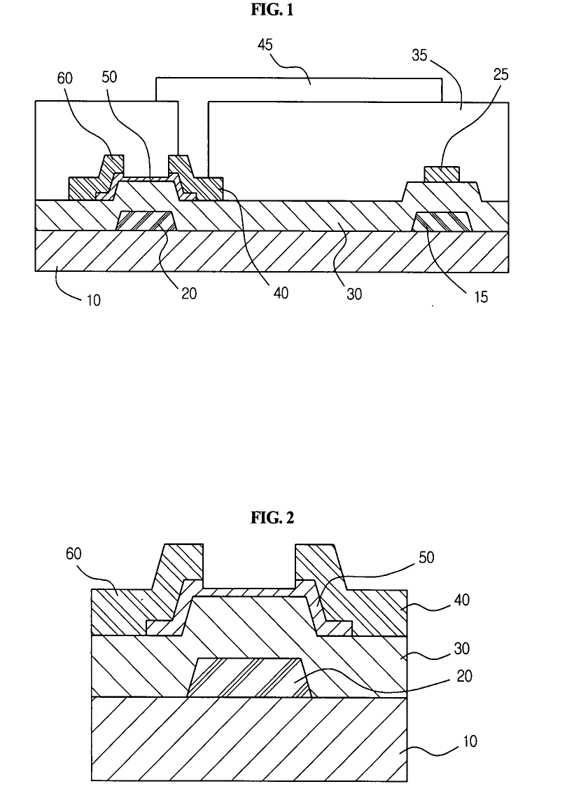

### DETAILED DESCRIPTION OF EXAMPLE EMBODIMENTS

Hereinafter, a detailed description will be given of example embodiments, with reference to the appended drawings. In the drawings, the thicknesses of layers and regions may be exaggerated for clarity. Detailed illustrative example embodiments are disclosed herein. Specific structural and functional details disclosed herein are merely representative for purposes of describing example embodiments. Example embodiments may, however, be embodied in many alternate forms and should not be construed as limited to only the example embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of example embodiments. Like numbers refer to like elements throughout the description of the figures.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between” and/or “adjacent” versus “directly adjacent”).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the scope of example embodiments.

Spatially relative terms, such as “beneath”, “below”, “lower”, “above”, “upper” and the like, may be used herein for ease of description to describe one element or a feature's relationship to another element or feature as illustrated in the Figures. It will be understood that the spatially relative terms are intended to encompass different orientations of the device in use or operation in addition to the orientation depicted in the Figures. For example, if the device in the Figures is turned over, elements described as “below” or “beneath” other elements or features would then be oriented “above” the other elements or features. Thus, for example, the term “below” can encompass both an orientation which is above as well as below. The device may be otherwise oriented (rotated 90 degrees or viewed or referenced at other orientations) and the spatially relative descriptors used herein should be interpreted accordingly.

Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing. For example, an implanted region illustrated as a rectangle may have rounded or curved features and/or a gradient (e.g., of implant concentration) at its edges rather than an abrupt change from an implanted region to a non-implanted region. Likewise, a buried region formed by implantation may result in some implantation in the region between the buried region and the surface through which the implantation may take place. Thus, the regions illustrated in the figures are schematic in nature and their shapes do not necessarily illustrate the actual shape of a region of a device and do not limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The organic insulating film composition of example embodiments may include a polysiloxane polymer, a hydrophobic or hydrophilic controller, and a solvent. The organic insulating film composition of example embodiments may be composed of a crosslinkable polysiloxane polymer, and a hydrophilic or hydrophobic controller which has hydrophilicity or hydrophobicity equal to or similar to those of materials constituting the substrate and the electrode.

In example embodiments, the polysiloxane polymer may have a contact angle of about 50° or greater, for example, about 70° or greater. The polysiloxane polymer may be an organic-inorganic hybrid material obtained by hydrolyzing and polycondensing an organic silane compound, the organic silane compound being at least one compound selected from the group consisting of compounds represented by Formulas 1 to 3 below, or mixtures thereof:

SiX₁X₂X₃X₄ Formula 1

R₁SiX₁X₂X₃ Formula 2

R₁R₂SiX₁X₂ Formula 3

in Formulas 1 to 3, X₁, X₂, X₃ and X₄ may be each independently selected from the group consisting of a halogen atom, a substituted or unsubstituted C₁-C₂₀ alkoxy group, and a substituted or unsubstituted C₆-C₂₀ aryloxy group, at least one of which may be a hydrolysable functional group, and

R₁ and R₂ may be each independently selected from the group consisting of a hydrogen atom, a halogen atom, a hydroxyl group, a substituted or unsubstituted C₁-C₂₀ alkyl group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ arylalkyl group, a substituted or unsubstituted C₁-C₂₀ alkoxy group, and a substituted or unsubstituted C₆-C₂₀ aryloxy group.

In addition, the polysiloxane polymer of example embodiments may be a polymer obtained by capping the end of the hydroxyl group of the organic-inorganic hybrid material resulting from hydrolysis and polycondensation of the organic silane compound with a compound represented by any one among Formulas 4 to 6 below:

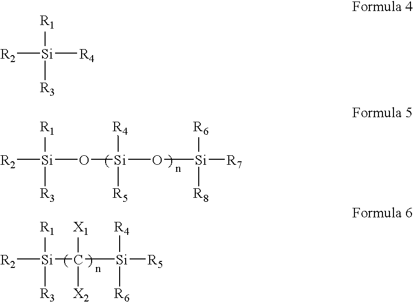

in Formulas 4 to 6, R₁, R₂, R₃, R₄, R₅, R₆, R₇ and R₈ may be each independently selected from the group consisting of a hydrogen atom, a hydroxyl group, a halogen atom, a substituted or unsubstituted C₁-C₂₀ alkyl group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ arylalkyl group, a substituted or unsubstituted C₁-C₂₀ alkoxy group, and a substituted or unsubstituted C₆-C₂₀ aryloxy group, at least one of which may be a hydrolysable functional group,

X₁ and X₂ may be each independently selected from the group consisting of a halogen atom, a substituted or unsubstituted C₁-C₂₀ alkoxy group, and a substituted or unsubstituted C₆-C₂₀ aryloxy group, and

n may be an integer of 0˜50.

In Formulas 1 to 6, the term “substituted” denotes substitution by an acryl group, an amino group, a hydroxyl group, a carboxyl group, an aldehyde group, an epoxy group and/or a nitrile group.

In the organic insulating film composition of example embodiments, the hydrophobic or hydrophilic controller may be at least one selected from the group consisting of polyvinylbutyral, a vinylmethoxysiloxane copolymer, and poly(3-(methacryloxyoxypropyl)siloxane, but example embodiments may not be limited thereto. The type and concentration of such a hydrophobic or hydrophilic controller may vary depending on the hydrophobic or hydrophilic properties of the substrate and the electrode.

The solvent used in example embodiments may not be particularly limited, and any solvent may be used so long as it may be used in the preparation of an organic insulating film, and may include, for example, at least one selected from the group consisting of an aliphatic hydrocarbon solvent, an aromatic hydrocarbon solvent, a ketone-based solvent, an ether-based solvent, an acetate-based solvent, an alcohol-based solvent, an amide-based solvent, a silicon-based solvent, and mixtures thereof, for example, an aliphatic hydrocarbon solvent, e.g., hexane and/or heptane; an aromatic hydrocarbon solvent, e.g., toluene, pyridine, quinoline, anisol, mesitylene and/or xylene; a ketone-based solvent, e.g., cyclohexanone, methylethyl ketone, 4-heptanone, methylisobutyl ketone, 1-methyl-2-pyrrolidinone, cyclohexanone and/or acetone; an ether-based solvent, e.g., tetrahydrofuran and/or isopropyl ether; an acetate-based solvent, e.g., ethyl acetate, butyl acetate and/or propyleneglycol methyl ether acetate; an alcohol-based solvent, e.g., isopropyl alcohol and/or butyl alcohol; an amide-based solvent, e.g., dimethylacetamide and/or dimethylformamide; a silicon-based solvent and/or mixtures thereof. A solvent system or solvent mixture of two or more of the solvents in any miscible ratio may also be used.

The organic insulating film composition of example embodiments may include about 100 parts by weight of the polysiloxane polymer, about 0.7˜7 parts by weight of the hydrophobic or hydrophilic controller and about 100˜400 parts by weight of the solvent.

The organic insulating film composition of example embodiments may further include at least one organic metal compound selected from among a titanium compound, a zirconium compound, a hafnium compound, and an aluminum compound, in order to obtain a uniform composition. Specifically, the organic metal compound may include titanium (IV) n-butoxide, titanium (IV) t-butoxide, titanium (IV) ethoxide, zirconium (IV) n-butoxide, zirconium (IV) t-butoxide, zirconium (IV) ethoxide, hafnium (IV) n-butoxide, hafnium (IV) t-butoxide, or hafnium (IV) ethoxide.

The organic insulating film composition of example embodiments may further include at least one binder selected from the group consisting of polyvinylacetal or polyvinylacetal derivatives, polyvinylalcohol or polyvinylalcohol derivatives, polyvinylphenol or polyvinylphenol derivatives, polyacryl or polyacryl derivatives, polynorbornene or polynorbornene derivatives, polyethyleneglycol derivatives, polypropyleneglycol derivatives, polysiloxane derivatives, cellulose derivatives, epoxy resins, melamine resins, glyoxal, and copolymers thereof. The binder may include a polar group, e.g., a hydroxyl group, a carboxyl group or salts thereof, a phosphoric acid group or salts thereof, a sulfonic acid group or salts thereof and/or an amine group or salts thereof, at the end of the main chain or side chain thereof. Such an organic metal compound may be included in an amount of about 0.01˜20 parts by weight, based on about 100 parts by weight of the polysiloxane polymer.

In addition, example embodiments pertain to a method of manufacturing the organic insulating film. The method of example embodiments may include coating a substrate having an electrode formed thereon with an organic insulating film composition having hydrophobicity or hydrophilicity equal to or similar to both the substrate and the electrode, thus forming an insulating film having a dual thickness. As such, as the composition, the organic insulating film composition of example embodiments mentioned above may be used.

Before the formation of the organic insulating film, the substrate may be used by washing it according to a typical process, and the gate electrode may be formed through deposition and patterning. The substrate may be formed of glass, silicon and/or plastic. The material for the gate electrode may include metal, metal oxide, or a conductive polymer, and may be specifically selected from the group consisting of a single metal, including gold, silver, aluminum, molybdenum, chromium, titanium, nickel, tantalum, tungsten or neodymium, alloys thereof, metal oxide, including ITO, IZO, ZnO or In₂O₃, and a conductive polymer, including polythiophene, polyaniline, polyacetylene, polypyrrole, polyphenylene vinylene or a mixture of PEDOT (polyethylenedioxythiophene) and PSS (polystyrenesulfonate).

The formation of the organic insulating film may be conducted by applying the organic insulating film composition and then soft baking and hard baking the organic insulating film. The process of applying the organic insulating film composition may be performed through a coating process, e.g., spin coating, dip coating, roll coating, screen coating, spray coating, flow coating, screen printing, ink jetting and/or drop casting. The coating process may be spin coating from the point of view of convenience and uniformity. Where a spin coating process is adopted, the spinning speed may be set within the range from about 400 rpm to about 5000 rpm.

Because the substrate has greater hydrophobicity than the electrode and the electrode has less hydrophobicity than the substrate, when applying an organic insulating film composition having hydrophilicity or hydrophobicity equal to or similar to both the substrate and the electrode, a difference in thickness thereof may be created, and the resulting organic insulating film may have a dual thickness.

In the method of example embodiments, the difference in thickness of the organic insulating film may be controlled by adjusting the concentration of the hydrophobic (or hydrophilic) controller of the organic insulating film composition. Where the polysiloxane polymer of the composition of example embodiments may be a material that is more hydrophobic in the metal electrode and where the hydrophobic controller may be a material having interfacial properties such that it is attracted to the metal more than the polysiloxane polymer, as the amount of the hydrophobic controller may be increased, the increased hydrophobicity of the polysiloxane polymer relative to the metal electrode may be gradually changed to hydrophilicity. While a phenomenon in which the polysiloxane polymer repels the metal is lessened, the thickness difference may be decreased. After the application of the organic insulating film composition, a baking process may include soft baking at about 70° C.˜about 100° C. for about 10 min˜about 30 min and then hard baking at about 180° C.˜about 250° C. for about 1.5 hours˜about 2 hours.

In addition, example embodiments pertain to an organic insulating film having a dual thickness, manufactured using the organic insulating film composition mentioned above. The organic insulating film of example embodiments may have a dual thickness because the organic insulating film may be formed thinner on the upper portion of the electrode than on the upper portion of the substrate. As such, the thickness difference between the upper portion of the electrode and the upper portion of the substrate may be about 1000 [symbol] ˜about 5000 [symbol] .

The method of manufacturing the organic insulating film of example embodiments may be applied to the manufacture of the silicon TFT or OTFT. Where the method of example embodiments is applied to the manufacture of the OTFT, because an additional bank process for forming an organic semiconductor layer is not required, the manufacturing process may be simplified and thus the manufacturing cost may be decreased.

Using the method of example embodiments, the OTFT may be manufactured in a manner such that the organic insulating film composition, having hydrophobility or hydrophilicty equal or similar to both the substrate and the gate electrode, may be applied on the substrate having the gate electrode formed thereon, thus the gate insulating film may be formed to have a dual thickness. When the organic insulating film having a dual thickness is provided, a groove may be formed by such a thickness difference.

After the formation of the organic insulating film having a dual thickness as mentioned above, an organic semiconductor layer may be formed on the bottom of the groove formed by the thickness difference, thereby manufacturing an OTFT. Examples of the material for the organic semiconductor layer may include, but may not be limited to, pentacene, copper phthalocyanine, polythiophene, polyaniline, polyacetylene, polypyrrole, polyphenylenevinylene, and derivatives thereof. The organic semiconductor may be made of amorphous silicon and/or polysilicon silicon. The processes in addition to the formation of the organic insulating film and the organic semiconductor layer may be conducted using the same method as a conventional method.

Moreover, example embodiments pertain to a TFT including the organic insulating film having a dual thickness manufactured using the above method. The organic insulating film of example embodiments may be applied to a conventional silicon TFT, as well as the OTFT.

FIG. 4 is a schematic cross-sectional view of the silicon TFT including the organic insulating film having a dual thickness of example embodiments. As shown in FIG. 4, the silicon TFT manufactured using the organic insulating film of example embodiments may include a substrate 210, a gate electrode 220, a gate insulating film 230, a semiconductor layer 250, a source electrode 260, and a drain electrode 280. In addition, the structure of the TFT of example embodiments may be varied.

As in FIG. 4, the gate insulating film 230 of the TFT of example embodiments may be formed to a larger thickness d₁ on the upper portion of the substrate and may be formed to a smaller thickness d₂ on the upper portion of the gate electrode. Because the substrate has relatively greater hydrophobicity than the electrode and the electrode has less hydrophobicity than the substrate, when an organic insulating film composition having hydrophilic or hydrophobic properties equal to or similar to both the substrate and the electrode is applied, the thickness difference as above may be created, resulting in an organic insulating film having a dual thickness.

In the TFT including the organic insulating film having a dual thickness, because the insulator is thinly formed on the upper portion of the gate electrode where the channel is formed, charge mobility and current in an on-state (Iₒₙ) may be increased. Further, the thickness of the insulator of a storage capacitor region may be decreased, and thus the capacity of the capacitor may be increased, leading to a decreased storage area. Thereby, the aperture ratio may be increased, and therefore a display screen having increased image quality may be provided. Because the insulating film of example embodiments is formed to be relatively thick between the gate electrode and the source/drain electrodes, parasitic capacitance, which may occur therebetween, may be decreased, thus controlling a flickering phenomenon.

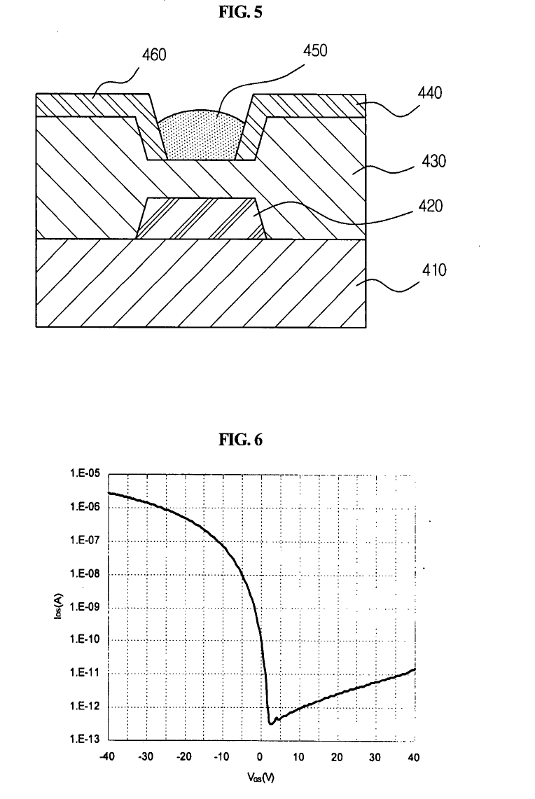

As shown in FIG. 5, an OTFT of example embodiments may include a substrate 410, a gate electrode 420, a gate insulating film 430, an organic semiconductor layer 450, a source electrode 460, and a drain electrode 440, in which the organic semiconductor layer 450 is formed on the bottom of a groove formed by the difference in thickness of the gate insulating film 430 having a dual thickness. In addition, the OTFT may have various structures, including a top contact structure and a top gate structure.

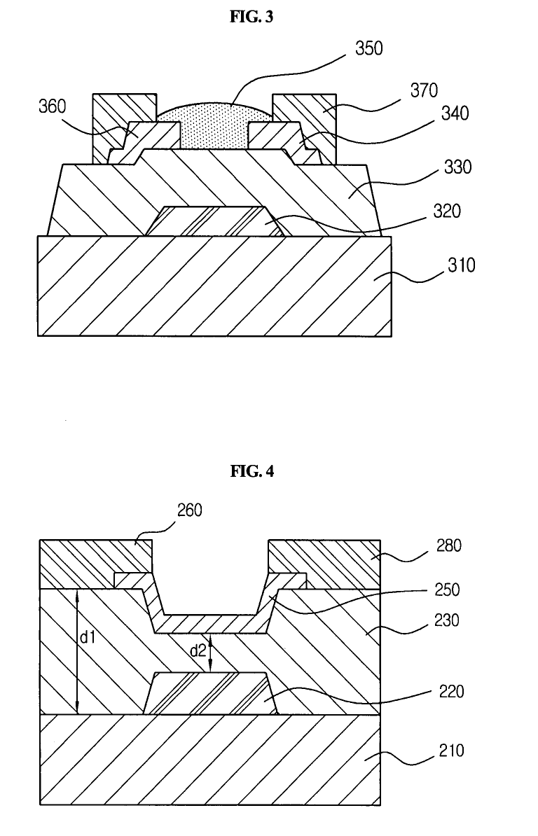

Unlike the conventional OTFT shown in FIG. 3, the OTFT of example embodiments of FIG. 5 may have a gate insulating film having a thickness difference, which makes the natural formation of a bank possible, consequently requiring no additional bank formation process. The TFT of example embodiments may have improved properties, e.g., increased charge mobility and a increased aperture ratio, and may be easily manufactured, and thus may be applied to various display devices, e.g., LCDs and/or OLEDs. A TFT may be effectively applied to various electronic devices, e.g., photovoltaic devices, plastic sensors, flexible RFIDs, memory and/or integrated circuits.

A better understanding of example embodiments may be obtained in light of the following examples which are set forth to illustrate, but are not to be construed to limit example embodiments.

### PREPARATIVE EXAMPLE

### Preparation of Organic Insulating Film Composition

Oct-7-ene-1-trichlorosilane polymer (OETS), titanium t-butoxide, and polyvinylphenol (Mw about 8,000) were mixed at a weight ratio of about 80:15:5, and then dissolved in cyclohexanone, thus preparing an about 20 wt % organic insulating film composition solution.

### EXAMPLE 1

### Manufacture of Silicon TFT

On a washed glass substrate, a gate electrode having a thickness of about 150/3000/500 [symbol] using Mo/Al/Mo was formed, and was then coated with the organic insulating film composition of Preparative Example using a spin coating process at about 2000 rpm to a thickness of about 8,000 [symbol] . Subsequently, the substrate was soft baked at about 70° C. for about 30 min and then hard baked at about 200° C. for about 1 hour, thus forming an organic insulating film. Thereafter, amorphous silicon and doped amorphous silicon were continuously deposited, after which a channel region was patterned through photolithography and etching. Then, source-drain electrodes were formed, and back channel etching was conducted, thus manufacturing an amorphous silicon TFT having a BCE (Back Channel Etch) structure.

### EXAMPLE 2

### Manufacture of OTFT

On a washed glass substrate, a gate electrode having a thickness of about 800 [symbol] was formed from aluminum, and was then coated with the organic insulating film composition of Preparative Example using a process of spin coating at about 2000 rpm to a thickness of about 8,000 [symbol] . Subsequently, the substrate was soft baked at about 70° C. for about 30 min and then hard baked at about 200° C. for about 1 hour, thus forming an organic insulating film.

On the insulating film, Au source/drain electrodes having a channel length of about 100 μm, a channel width of about 1 mm, and a thickness of about 700 [symbol] were formed, after which a pentacene organic semiconductor layer having a thickness of about 700 Å was formed through thermal evaporation, thereby manufacturing an OTFT having a bottom contact structure shown in FIG. 6. When measuring the transfer properties of the OTFT of example embodiments, the OTFT was confirmed to have electrical mobility of about 0.19 cm²/Vs and a threshold voltage of about −10 V.

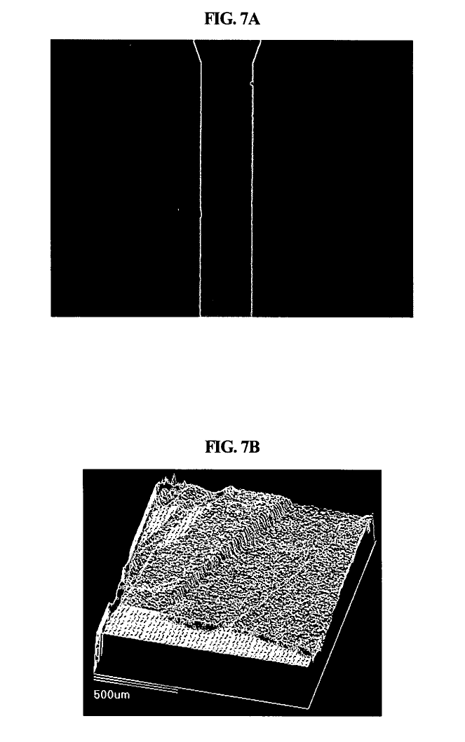

The SEM pictures of the insulating film thus obtained are shown in FIGS. 7A and 7B. FIG. 7A is an SEM picture of the organic insulating film manufactured in the example, and FIG. 7B is a three-dimensionally reconstructed image of the SEM picture of FIG. 7A. As shown in FIG. 7A, the insulating film was confirmed to have a dual thickness. Further, from FIG. 7B showing the three-dimensional structure, the insulating film manufactured in the example of example embodiments was confirmed to have a dual thickness.

As described hereinbefore, example embodiments provide an organic insulating film composition and a method of manufacturing an organic insulating film having a dual thickness using the same. According to example embodiments, the organic insulating film formed using the organic insulating film composition has a smaller thickness on the upper portion of an electrode and has a larger thickness on the upper portion of the substrate using the hydrophilic (or hydrophobic) difference between the substrate and the electrode. Therefore, a TFT including the organic insulating film of example embodiments may have improved electrical properties and decreased parasitic capacitance, thereby effectively controlling a flickering phenomenon.

When the organic insulating film composition of example embodiments is applied to an OTFT, no additional bank process for forming an organic semiconductor layer may be required, and hence the manufacturing process may be simplified, resulting in decreased manufacturing cost.

Further, according to the method of example embodiments, upon the manufacture of the TFT, an insulting film having a dual thickness may be formed through a single process without the need for an additional process.

Although example embodiments have been disclosed for illustrative purposes, those skilled in the art will appreciate that various modifications, additions and substitutions are possible, without departing from the scope and spirit of the accompanying claims.

What is claimed is:

1. An organic insulating film composition, comprising:
a polysiloxane polymer;
a hydrophobic or hydrophilic controller; and
a solvent.

2. The composition as set forth in claim 1, wherein the polysiloxane polymer has a contact angle of about 50° or greater.

3. The composition as set forth in claim 1, wherein the polysiloxane polymer is an organic-inorganic hybrid material obtained by hydrolyzing and polycondensing at least one organic silane compound selected from the group consisting of compounds represented by Formulas 1 to 3 below, or mixtures thereof:
SiX₁X₂X₃X₄ Formula 1
R₁SiX₁X₂X₃ Formula 2
R₁R₂SiX₁X₂ Formula 3
in Formulas 1 to 3, X₁, X₂, X₃ and X₄ are each independently selected from the group consisting of a halogen atom, a substituted or unsubstituted C₁-C₂₀ alkoxy group, and a substituted or unsubstituted C₆-C₂₀ aryloxy group, at least one of which is a hydrolysable functional group, and
R₁ and R₂ are each independently selected from the group consisting of a hydrogen atom, a halogen atom, a hydroxyl group, a substituted or unsubstituted C₁-C₂₀ alkyl group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ arylalkyl group, a substituted or unsubstituted C₁-C₂₀ alkoxy group, and a substituted or unsubstituted C₆-C₂₀ aryloxy group.

4. The composition as set forth in claim 3, wherein the polysiloxane polymer is a polymer obtained by capping an end of a hydroxyl group of the organic-inorganic hybrid material, obtained by hydrolyzing and polycondensing the organic silane compound, with a compound represented by any one among Formulas 4 to 6 below: 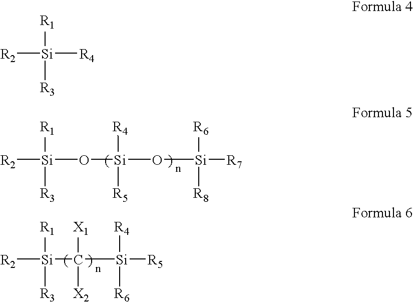
in Formulas 4 to 6, R₁, R₂, R₃, R₄, R₅, R₆, R₇ and R₈ are each independently selected from the group consisting of a hydrogen atom, a hydroxyl group, a halogen atom, a substituted or unsubstituted C₁-C₂₀ alkyl group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ arylalkyl group, a substituted or unsubstituted C₁-C₂₀ alkoxy group, and a substituted or unsubstituted C₆-C₂₀ aryloxy group, at least one of which is a hydrolysable functional group,
X₁ and X₂ are each independently selected from the group consisting of a halogen atom, a substituted or unsubstituted C₁-C₂₀ alkoxy group, and a substituted or unsubstituted C₆-C₂₀ aryloxy group, and
n is an integer of 0˜50.

5. The composition as set forth in claim 1, wherein the hydrophobic or hydrophilic controller is at least one selected from the group consisting of polyvinylbutyral, a vinylmethoxy siloxane copolymer, and poly(3-(methacryloxyoxypropyl)siloxane).

6. The composition as set forth in claim 1, wherein the solvent is at least one selected from the group consisting of an aliphatic hydrocarbon solvent, an aromatic hydrocarbon solvent, a ketone-based solvent, an ether-based solvent, an acetate-based solvent, an alcohol-based solvent, an amide-based solvent, a silicon-based solvent, and mixtures thereof.

7. The composition as set forth in claim 1, which includes:
100 parts by weight of the polysiloxane polymer;
0.7˜7 parts by weight of the hydrophobic or hydrophilic controller; and
100˜400 parts by weight of the solvent.

8. A method of manufacturing an organic insulating film having a dual thickness, comprising:
coating a substrate having an electrode formed thereon with an organic insulating film composition having hydrophobicity or hydrophilicity equal to or similar to both the substrate and the electrode, thus forming an organic insulating film having a dual thickness.

9. The method as set forth in claim 8, wherein the organic insulating film composition includes a polysiloxane polymer, a hydrophobic or hydrophilic controller and a solvent.

10. The method as set forth in claim 8, wherein the organic insulating film composition includes an organic-inorganic hybrid material obtained by hydrolyzing and polycondensing at least one organic silane compound selected from the group consisting of compounds represented by Formulas 1 to 3 below, or mixtures thereof:
SiX₁X₂X₃X₄ Formula 1
R₁SiX₁X₂X₃ Formula 2
R₁R₂SiX₁X₂ Formula 3
in Formulas 1 to 3, X₁, X₂, X₃ and X₄ are each independently selected from the group consisting of a halogen atom, a substituted or unsubstituted C₁-C₂₀ alkoxy group, and a substituted or unsubstituted C₆-C₂₀ aryloxy group, at least one of which is a hydrolysable functional group, and
R₁ and R₂ are each independently selected from the group consisting of a hydrogen atom, a halogen atom, a hydroxyl group, a substituted or unsubstituted C₁-C₂₀ alkyl group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ arylalkyl group, a substituted or unsubstituted C₁-C₂₀ alkoxy group, and a substituted or unsubstituted C₆-C₂₀ aryloxy group.

11. The method as set forth in claim 8, wherein forming the insulating film includes applying the organic insulating film composition and conducting soft baking and hard baking.

12. The method as set forth in claim 11, wherein applying the organic insulating film is conducted by subjecting the organic insulating film composition to spin coating, dip coating, roll coating, screen coating, spray coating, flow coating, screen printing, ink jetting, or drop casting.

13. The method as set forth in claim 8, wherein the substrate is a glass substrate, a silicon substrate, or a plastic substrate.

14. The method as set forth in claim 8, wherein the electrode is formed of a material selected from the group consisting of a single metal, including gold, silver, aluminum, molybdenum, chromium, titanium, nickel, silver, tantalum, tungsten or neodymium, alloys thereof, metal oxide, including ITO, IZO, ZnO or In₂O₃, and a conductive polymer, including polythiophene, polyaniline, polyacetylene, polypyrrole, polyphenylenevinylene or a mixture of PEDOT (polyethylenedioxythiophene) and PSS (polystyrenesulfonate).

15. The method as set forth in claim 8, which further includes:
adjusting a difference in thickness of the insulating film by controlling a concentration of a hydrophobic additive or a hydrophilic additive of the insulating film composition.

16. An organic insulating film having a dual thickness, formed using the method of claim 8.

17. The insulating film as set forth in claim 16, which is formed thinner on an upper portion of an electrode than on an upper portion of a substrate to create a difference in thickness.

18. The insulating film as set forth in claim 17, wherein the insulating film has the difference in thickness between the upper portion of the electrode and the upper portion of the substrate ranging from about 1000 [symbol] to about 5000 [symbol] .

19. A thin film transistor, including the organic insulating film of claim 16.

20. The transistor as set forth in claim 19, which is a silicon thin film transistor or an organic thin film transistor.

21. The transistor as set forth in claim 20, wherein the organic thin film transistor has a bottom contact structure, a top contact structure, or a top gate structure.

22. A method of manufacturing an organic thin film transistor, comprising:
performing the method of manufacturing the organic insulating film having a dual thickness in claim 8; and
forming an organic semiconductor layer on a bottom of a groove formed by a difference in thickness of the gate insulating film.

23. A display device including the thin film transistor of claim 19.

24. An electronic device including the thin film transistor of claim 19.

25. A polysiloxane polymer composition comprising:
an organic-inorganic hybrid material obtained by hydrolyzing and polycondensing at least one organic silane compound selected from the group consisting of compounds represented by Formulas 1 to 3 below, or mixtures thereof:
SiX₁X₂X₃X₄ Formula 1
R₁SiX₁X₂X₃ Formula 2
R₁R₂SiX₁X₂ Formula 3
in Formulas 1 to 3, X₁, X₂, X₃ and X₄ are each independently selected from the group consisting of a halogen atom, a substituted or unsubstituted C₁-C₂₀ alkoxy group, and a substituted or unsubstituted C₆-C₂₀ aryloxy group, at least one of which is a hydrolysable functional group, and
R₁ and R₂ are each independently selected from the group consisting of a hydrogen atom, a halogen atom, a hydroxyl group, a substituted or unsubstituted C₁-C₂₀ alkyl group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ arylalkyl group, a substituted or unsubstituted C₁-C₂₀ alkoxy group, and a substituted or unsubstituted C₆-C₂₀ aryloxy group.

26. The composition as set forth in claim 25, wherein the polysiloxane polymer is a polymer obtained by capping an end of a hydroxyl group of the organic-inorganic hybrid material, obtained by hydrolyzing and polycondensing the organic silane compound, with a compound represented by any one among Formulas 4 to 6 below: 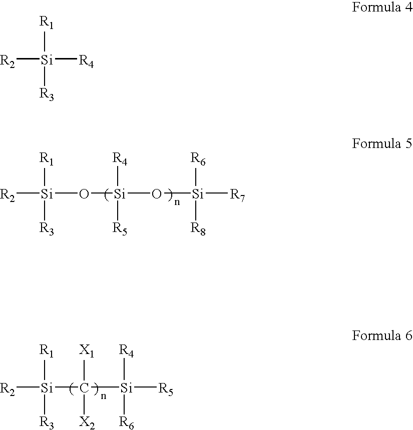
in Formulas 4 to 6, R₁, R₂, R₃, R₄, R₅, R₆, R₇ and R₈ are each independently selected from the group consisting of a hydrogen atom, a hydroxyl group, a halogen atom, a substituted or unsubstituted C₁-C₂₀ alkyl group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ arylalkyl group, a substituted or unsubstituted C₁-C₂₀ alkoxy group, and a substituted or unsubstituted C₆-C₂₀ aryloxy group, at least one of which is a hydrolysable functional group,
X₁ and X₂ are each independently selected from the group consisting of a halogen atom, a substituted or unsubstituted C₁-C₂₀ alkoxy group, and a substituted or unsubstituted C₆-C₂₀ aryloxy group, and
n is an integer of 0˜50.
